(19) United States
(12) Patent Application Publication
(10) Pub. No.: US 2025/0251328 A1
(43) Pub. Date: Aug. 7, 2025

(54) AN EFFICIENT VOLUMETRIC HIGH PRESSURE ADSORPTION ISOTHERM APPARATUS AND A PROCESS THEREOF

(71) Applicant: COUNCIL OF SCIENTIFIC AND INDUSTRIAL RESEARCH, New Delhi (IN)

(72) Inventors: Debadutta Mohanty, Dhanbad (IN); Sujoy Chattaraj, Dhanbad (IN)

(21) Appl. No.: 18/856,101

(22) PCT Filed: Apr. 11, 2023
(86) PCT No.: PCT/IN2023/050355

§ 371 Date: Oct. 11, 2024

(30) Foreign Application Priority Data
Apr. 12, 2022 (IN) 202211022001

(51) Int. Cl. G01N 7/04

(52) U.S. Cl. CPC G01N 7/04

(57) ABSTRACT

The present invention discloses an apparatus and process for measuring the maximum gas adsorption/desorption capacity of a powdered solid sample, particularly coal/shale, by volumetric method. It is innovative in a way that it can perform adsorption/desorption isotherm measurements for a set of four samples simultaneously, where four separate channel has been fabricated through a single gas injection point. As the natural adsorbent samples may be from different burial depths, the apparatus is capable of carrying out adsorption/desorption measurements simultaneously on four samples at different temperatures corresponding to their depth through a compartmentalized water bath system. Apart from that, the apparatus can measure adsorbed gas capacity up to a very high pressure of 40 MPa replicating the reservoir depth up to 4000 m. Moreover, sample vessels are also able resist 6000 Psi pressure. The apparatus is also enabling to handle the toxic, reactive and highly flammable gases. Mentioning high temperature with an accuracy of 0.1° C. is another unique feature of the present invention. The apparatus finds its application for the gas storage capacity and recoverable reserve estimation for CBM, Shale gas and CO₂ geo-sequestration projects.

The following specification particularly describes the invention and the manner in which it is to be performed.

### FIELD OF THE INVENTION

The present invention relates to an efficient volumetric high pressure adsorption isotherm [AI] apparatus. Particularly, the present invention relates to an apparatus which is able to measure the adsorption capacity up to a maximum pressure of 40 MPa corresponding to 4000 m depth of burial. More particularly, the present invention relates to the apparatus useful to measure the maximum gas adsorption capacity of a solid sample, particularly coal/shale, by volumetric method.

### BACKGROUND OF THE INVENTION

Reference may be made to U.S. Pat. No. 2,692,497, wherein a system has been disclosed and claimed for an apparatus to obtain data comprising a vacuum-tight chamber with a gas passage, gravimetric means in solid chamber which supports said solids, means to maintain that part of said chamber which supports said solids at a substantially constant temperature. The inventor claims a novel, automated, adsorption isotherm apparatus with simple, speedy, and accurate measurement of adsorption capacity of porous solid samples. The invention also claims the measurement of gas volume adsorbed in fraction of the time. The patent disclosed only the process for adsorption isotherms of finely divided and porous solid including the adsorption desorption branches of the isotherms and more over it does not show any temperature variance. In this invention, isotherm has been measured within a few minutes, so it does not maintain the equilibrium condition. Further, this invention did not mention any pressure range at which the apparatus is operational.

Reference may be made to U.S. Pat. No. 2,960,870, wherein a system has been disclosed and claimed for an apparatus which measures the surface area by BET adsorption isotherm method with much effective measurement and with more surface coverage area comparatively in low cost with the original one. Yet another objective of this invention is to provide a surface area measurement method and apparatus by flowing gas mixture stream. A further object of the invention is to provide an apparatus for the determination of surface areas which is much less costly than those required for the BET method and the Bureau of Standards modification thereof, does not require vacuum equipment, and is suitable for manufacture and sale as a standard piece of laboratory equipment. The patent disclosed only the method of surface area measurement by using nitrogen as an adsorbate. This invention also claims that 1 m³ of N₂ can cover nearly about 2.84 m² of an area at 1 atm pressure and 25° C. for monolayer adsorption. Hence, the invention is limited to the specific adsorbate gas that to inert gas N₂, whereas it varies for different adsorbates. Further, the present invention does not fit for the high pressure adsorption isotherm

Reference may be made to U.S. Pat. No. 3,555,912, wherein a system has been disclosed and claimed for an apparatus which relates to surface area measurement of the solid material, particularly those are in particulate form. The present invention provides the technique of adsorbing the adsorbate from a flowing mixture of the carrier gas and adsorbate, from which determines the change in concentration in the gas flow, after isolating the powdered sample cell form the said predetermined mixture by establishing a concentration of adsorbate from that inventor has measured the concentration differences. The patent disclose only the method of determining the change in concentration at various pressure but do not consider any temperature effect with the varying pressure because concentration change has a significant negative impact with an increase in temperature and isotherm curves at deviates at different temperature. Moreover, in this invention, authors have fabricated the apparatus with a single sample cell; there is no arrangement for the multiple samples at a single experiment and does not have any liquid bath to maintain the temperature. The present invention does not have provision to maintain different temperatures at a single experiment for the heating or cooling of the reactor.

Reference may be made to U.S. Pat. No. 3,732,736, wherein a system has been disclosed and claimed for an apparatus for measuring adsorption for the specific surfaces of porous or divided solids which gives the critical information of pore radius of 20-350 Å, specific surface area of solids at low temperature. The dynamic volumetric method of adsorption is capable to do the experiment with a very small amount of sample of less than one gram. With this, it is also useful because equal quantity of adsorbate come from a chamber of constant volume is separated from the sample-carrying chamber by a valve, which is open during each stage and enables the pressures in the two chambers to be equilibrated and close before the next stage. The patent disclose only the method of measuring adsorption of solid and powdered sample at only low pressure, BET isotherm only satisfies this type of adsorption isotherm Frendluich and Langmuir does not satisfy it properly so, the invention is not versatile. Not only this, there is no arrangement of measure the sample of high temperature and high-pressure reservoir. Reference may be made to U.S. Pat. No. 3,771,367, wherein a system has been disclosed and claim for an apparatus and techniques of exposing said surface to flowing adsorbate and carrier gases and method of constructing the desorption isotherm for a test said powder and for the scanning hysteresis region of the said curve as well as that of the adsorption curve which bound the opposite extent thereof. The patent disclose only the process of desorption/adsorption study of pure nitrogen and nitrogen-inert gas mixture. In this invention inventor has passes the pure nitrogen gas or adsorbate first and then passes the mixture gas of pure nitrogen and helium, they have not calculated the total void volume of the micropore, mesopore or macropore present in the adsorbent. Hence volumetric measurement in this process is not appropriate. Reference may be made to patent application US20090025403 and U.S. Pat. No. 5,109,716, wherein a system has been disclosed and claimed for an adsorption heat pump employing a specific adsorbent and use of the specific adsorbent as an adsorbent for an adsorption heat pump. An adsorption heat pump is provided in which water vapour can be efficiently adsorbed and desorbed using a heat source having a lower temperature than ones heretofore in use because the pump employs an adsorbent which has a large difference in water adsorption amount in adsorption/desorption and can be regenerated at a low temperature. The systems disclose only the process of adsorption of water vapour in the adsorbent. But it does not elaborate any process of adsorption on the solid sample; the adsorbents have a large difference in water vapour adsorption amount with the other absorbate. Besides that, it only measures the adsorption isotherm on a very low pressure range, but the isotherm curves mainly deviate in high pressure range.

Reference may be made to U.S. Pat. No. 5,239,482, wherein a system has been disclosed and claimed for an apparatus for continuously measuring the adsorption-desorption isotherms of gases from solid sample. The patent only discloses the process of nitrogen adsorption at low pressure, but pattern of sorption is different for different gases. The sorption behaviour gets changes at high pressure and the here the mentioning the data of small interval is not possible, where as in my invention of this apparatus small interval with the data acquisition system. Sorption test at different temperatures is not possible here, as this invention is maintaining the constant temperature of the liquid nitrogen bath.

Reference may be made to U.S. Pat. No. 5,342,580, which has disclosed the method of adsorption and desorption Where in a system has been disclosed and claimed for an apparatus for measuring the amount of gas adsorbed or desorbed from a solid. With this, it also predicts the character of non-catalytic solid with its gas sorption capacity by nitrogen injection at 77° K. It founds the reaction capacity of gas and type of product formed by physical and chemical adsorption or desorption of a gas with at different pressure by volumetric method. The patent has disclosed the method of adsorption and desorption but above 1 atm pressure it is very low efficient. Reservoir pressure maximum time ranges above atmospheric pressure. Therefore, it is not possible to measure the sorption capacities at high pressure with only 0.1% full-scale efficiency. Moreover, its sample container vessel capacity is 1500 psi, whereas, the present inventor has made sample container of 6000 psi i.e. container vessel in the present invention can holds four time more pressure.

Reference may be made to U.S. Pat. No. 5,360,743, wherein a system has been disclosed and claimed for a measurement technique for performing adsorption and desorption gas analyses on materials. By employing the apparatus and method disclosed herein, the void volume is determined with the use of a non-adsorbable gas, such as helium. The patent discloses only method of the process of adsorption and desorption gas analysis of solid materials and it deals with a single sample cell whereas the present invention deals with four sample cell simultaneously, which can measure four different samples at four different condition.

Reference may be made to U.S. Pat. No. 5,591,897, wherein a system has been disclosed and claimed for an apparatus for measuring the gas absorbing and/or desorbing characteristics of a substance having a property to absorb a gas. The apparatus comprises a sample container for containing the adsorbent, a gas until a predetermined pressure is reached, a gas supply source for supplying the gas to the gas storage. The patent disclose only the method of single component sample cell system which cannot be conclude the effect of temperature for the same sample maintaining different temperature at separate water bath.

Reference may be made to U.S. Pat. No. 6,595,036, which disclose the process of measurement of desorbed gas at atmospheric pressure and temperature. Both reference cells and sample cells are immerged at cryogenic fluid temperature bath, the initial dead volume of the reference cell, and an initial gas pressure of the reference cell measured at a time point of the measurement of the initial dead volume of the reference cell. Then the initial dead volume of the sample cell preliminarily measured is corrected based on the change in the dead volume of the sample cell for the calculation of the amount of the gas adsorbed on the solid sample. The patent does not include temperature control unit, it measured desorbed gas at normal atmospheric temperature and pressure only. The system simply collects coal core from well site and then periodically measuring the volume of gas released inside the experimental setup at atmospheric pressure and temperature range. Hence, these methods are not accurate for measuring total gas desorption in coal core sample at reservoir condition.

The present invention relates to an apparatus for measuring the amount of gas adsorbed on a solid material and a method thereof.

Typical adsorption isotherm measures the volume of gas adsorbed into solid at constant temperature. Experimental data also validate some numerical expressions. Low pressure adsorption isotherm is analyzed to measure the surface area and pore volume of a powder sample. Diffusivity of gas in a solid can also be measured with the help of this experiment.

The amount of gas adsorbed on the solid sample with the increasing pressure and constant temperature provides an isotherm curve. The amount of gas is injected to the sample cell is measure by volumetric measurement. The pressure will increase and will be stable at an equilibrium pressure. When adsorption occurs onto the sample, the equilibrium pressure is greater than adsorption pressure. The amounts of gas adsorbed and the corresponding pressures in the sample cell are the data points of an adsorption isotherm. But some gases have significance effect after reaching the equilibrium pressure or beyond the equilibrium pressure known as excess adsorption.

Present invention relates to an adsorption study aimed at measurement of volume adsorbed at a particular pressure, which is of particular interest in connection with adsorption of gas on solid material mainly coal/shale. Such measurements are useful in characterizing many solids according to its gas adsorption capacity, surface area measurement and pore volume. For example, coal has an adsorption capacity due to its dual porosity. Adsorption isotherm can measure the adsorption capacity of different coal sample by injecting different gases. The amount of gas adsorbed is highly significant to calculate pore volume and surface area. Besides that, it is one of the important parameter in Coalbed methane reservoir characterization.

### OBJECTIVES OF THE INVENTION

Main objective of the present invention is to provide an apparatus for measuring the amount of gas adsorbed on a solid coal/shale samples.

Another objective of the present invention is to provide a method for measuring the amount of gas adsorbed on a solid coal/shale samples.

Yet another objective of the present invention is to provide an adsorption isotherm setup with integrated digital temperature control unit for measuring adsorbed gas.

Yet another objective of the present invention is to develop a setup of adsorption isotherm for measuring the adsorbed gas capacity up to a very high pressure of 40 MPa replicating the reservoir depth up to 4000 m.

Yet another objective of the present invention is to incorporate a water bath at the bottom of the adsorption isotherm setup to immerse the reference/reference cell fully with the water.

Yet another objective of the present invention is to incorporate heater within the water bath to maintain uniform temperature of coal/shale sample cell and four separate water chamber within a single water bath to maintain four different temperatures at a time.

Yet another objective of the present invention is to perform adsorption isotherm experiments of four samples simultaneously, where four separate channel has been fabricated through single gas injection point.

### A SUMMARY OF THE INVENTION

Accordingly, present invention provides an efficient volumetric high pressure adsorption isotherm apparatus [FIG. 1] comprising body of the adsorption isotherm apparatus [FIG. 1, A] in a water bath [FIG. 1, B];
wherein body of adsorption isotherm apparatus [FIG. 1, A] further comprises:
   a) Stainless steel reference cell [FIG. 1, A11-a] and sample cell [FIG. 1, A11-b] calibrated at a pressure range of 0 to 6000 psi;
   b) Digital temperature display unit [FIG. 1, A14-a] and thermocouple [FIG. 1, A14-b];
   c) Seamless tubing [FIG. 1, A1];
   d) Two-stage diaphragm-sensing pressure gauge (0-40 MPa) [FIG. 1, A2];
   e) Quick connect body [FIG. 1, A3];
   f) Quick connect stem [FIG. 1, A4];
   g) Check valve [FIG. 1, A5];
   h) NPT male connector [FIG. 1, A6];
   i) Bulkhead Male connector [FIG. 1, A7];
   j) Branch female NPT tee [FIG. 1, A8];
   k) 2-way (on-off) ball valve (¼ inch) [FIG. 1, A9];
   l) Strain gauge based pressure transducer [FIG. 1, A10];
   m) Stainless steel type particulate filter of 0.5 μm pore size [FIG. 1, A12];
   n) Mounting bracket for sample cylinder and bulkhead [FIG. 1, A13];

In yet another embodiment of the present invention, the water bath [FIG. 1, B] is separated in four sections for each of the channel to perform the experiment of four different samples in four different temperature at a time.

In yet another embodiment of the present invention, said apparatus is for determining the adsorption capacity of the solid adsorbent and for measuring desorption of gas from solid desorbent.

In yet another embodiment, present invention provides a process for determining the adsorption capacity of the solid adsorbent using the apparatus comprising the steps of:
i. moisture equilibrating the crushed coal samples (−72 mesh BSS) at 96-97% relative humidity to obtain equilibrated moisture coal sample;
ii. providing a known volume sample cell (150 cc) maintained at reservoir temperature with a continuous provision for gas injection vent out;
iii. putting the equilibrated moisture coal sample as obtained in step (i) into the sample cell of step (ii);
iv. evacuating the air present in reference cell, sample cell and tubing through vacuum pump;
v. maintaining the temperature of the water bath of the reference cell and sample cells at the desired temperature for the isotherm determination;
vi. closing the valves to vacuum pump and sample cells and opening the valves to reference cells;
vii. injecting the inert gas into the reference cell at known pressure followed by closing the valve to reference cells and allowing the temperature to equilibrate with water bath;
viii. connecting the reference cell with sample cell for temperature equilibrium;
ix. opening the valves of the sample cells, reference cells and vacuum lines; ix.
x. evacuating the whole system to ensure that there should not air or any other gases are present;
xi. closing the valves to vacuum pump and sample cells and opening the valves to reference cells;
xii. introducing the adsorbate gas into the reference cells at a different pressure steps;
xiii. closing the valves to reference cells and equilibrating the temperature with water bath for one hour;
xiv. opening the valves to sample cells and admitting the adsorbate gas to the sample cells;
xv. recording the temperature equilibrium and drop in pressure in the sample cell;
xvi. increasing the pressure in the reference cell to the next pressure step by adjusting the regulator on the gas cylinder;
xvii. repeating the steps at increasing pressures as per the desired pressure up to 40 MPa;
xviii. attending the equilibrium pressure at each step after reducing the pressure of the sample cell in a step-wise manner during desorption.

In yet another embodiment of the present invention, said inert gas is selected from helium or argon.

In yet another embodiment of the present invention, the adsorbate gas is injected at different pressure steps for the measurement adsorption capacity in multiple steps from the adsorption measured at successive point of time.

In yet another embodiment, present invention provides a process for determining desorption of gas from solid desorbent using the apparatus as claimed in claim 1, comprising the steps of:
i. providing an evacuated chamber/reference cell of known volume and maintained at a predetermined reservoir temperature with a vent out system;
ii. Previously degassed sample of desorbent present therein having the gaseous at equilibrium condition with the water bath temperature;
iii. establishing the equilibrium pressure of the gaseous desorbate as its being vent out from the sample cell as a function of adsorbate gas concentration;
iv. correlating the amount of gaseous desorbate and equilibrium pressure.

In yet another embodiment of the present invention, the gaseous adsorbate/desorbate is a physisorbate and the process occurs is fully physisorption.

In yet another embodiment of the present invention, the temperature of the water bath is maintained substantially throughout the desorbate venting out.

In yet another embodiment of the present invention, the adsorbent/desorbent are selected from coal or shale.

In yet another embodiment of the present invention, said adsorbate/desorbate gas is selected from the group consisting of methane, carbondioxide, nitrogen or any adsorbate/desorbate gas. In yet another embodiment of the present invention, the body of the adsorption isotherm apparatus [FIG. 1, A] consists of SS 304 Custom Panel with Support Frame.

In yet another embodiment of the present invention, vacuum pump is introduced to ensure the whole system air/any gas free prior to injection of adsorbate.

In yet another embodiment of the present invention, the inert gases like helium/argon are injected prior to injection of adsorbate gas to calculate the void volume within the sample cell containing the adsorbent.

In yet another embodiment of the present invention, four separate channel has been fabricated through which adsorption isotherm experiment of four samples can run simultaneously from single injection point.

In yet another embodiment of the present invention, the water bath is separated in four sections for each of the channel so the experiment of four different samples in four different temperature can be performed at a time.

In yet another embodiment of the present invention, the digital temperature display unit is mounted with the thermocouple to maintain constant temperature with a precision of ±0.1° C. throughout the experiment.

In yet another embodiment of the present invention, the desorbate gas is vent out at different pressure steps to construct the desorption isotherm in multiple steps from the at successive point of time.

### BRIEF DESCRIPTION OF THE DRAWING

FIG. 1 represents schematic diagram of the high pressure adsorption isotherm [AI] apparatus with integrated digital temperature control unit wherein [A] is the body of the adsorption isotherm apparatus which consists of different parts viz. Seamless tubing [A1]; Two-stage diaphragm-sensing pressure (0-40 MPa) [A2]; Quick connect body (¼ inch) [A3]; Quick connect stem (¼ inch) [A4]; SS Poppet Check valve (6000 psi) [A5]; NPT male connector [A6]; Bulkhead Male connector [A7]; Branch female NPT tee [A8]; 2-way (on-off) ball valve (¼ inch) [A9]; Strain gauge based pressure transducer (Range—0-40 MPa) [A10]; Stainless steel make reference cell [A11-a] and sample cell [A11-b] calibrated at a pressure amount of 6000 psi; Stainless steel type particulate filter of 0.5 μm pore size [A12]; Mounting bracket for sample cylinder and bulkhead [A13]; Digital temperature display unit [A14-a] and thermocouple [A14-b];
and [B] is a water bath.

FIG. 2 represents Methane adsorption/desorption isotherm construction of AI-CH₄/01 sample.

FIG. 3 represents Carbon dioxide adsorption/desorption isotherm construction of AI-CO₂/02 sample.

FIG. 4 represents mixture gas adsorption/desorption isotherm construction of AI-Mix/03 sample.

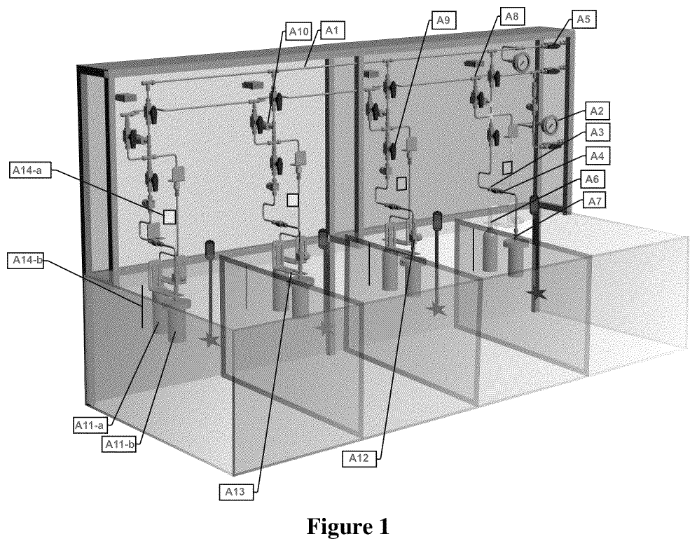

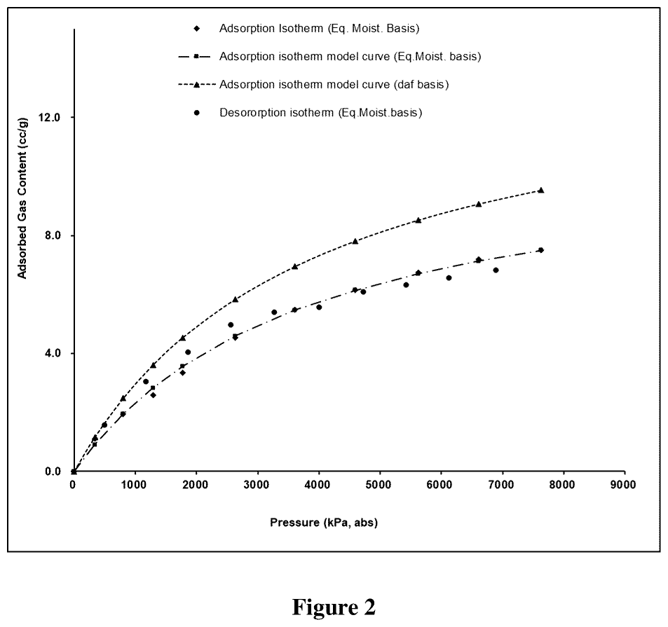

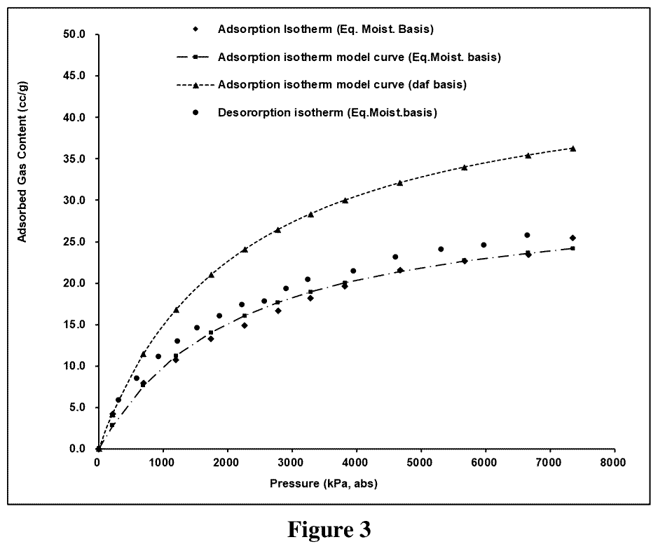

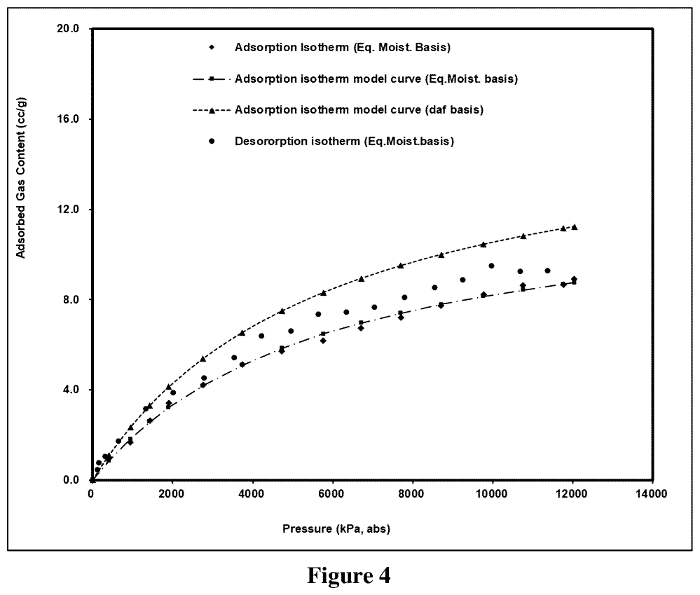

### DETAILED DESCRIPTION OF THE INVENTION

For advantageous use of solid materials such as powdery materials, adsorbents and films, it is important to obtain information on the specific surface area and pore size distribution of such a solid material. To obtain such information, it is necessary to prepare an adsorption isotherm by measuring gas adsorption on the solid material while maintaining the solid material at a constant temperature.

For example, a volumetric gas adsorption measuring apparatus is employed for the measurement of the gas adsorption on the solid material. The volumetric gas adsorption measuring apparatus includes: a manifold maintained at predetermined temperature (T) and having a known geo metric volume (Vₛ), a sample cell which contains a solid sample A and is connected to the manifold via a valve and a constant temperature bath which contains a cryogenic coolant such as liquid nitrogen. A gas inlet/outlet line is connected to the manifold via a valve, and a sample retaining portion of the sample cell is immersed in the cryogenic coolant contained in the constant temperature bath for maintaining the solid sample A at a cryogenic temperature.

With the use of the volumetric gas adsorption measuring apparatus, first the manifold and the sample cell are evacuated with the valves and being open. Then the gas is fed into the manifold with the valve being closed and the valve is closed. At this time point, a gas pressure (Pi) and the amount of a gas adsorbed on the solid sample A is measured.

The present invention discloses an experimental setup of adsorption isotherm for measuring adsorbed gas content on solid samples. It also provides a process for an estimation method for adsorbed gas of coal/shale sample present within the sample.

The present invention further provides an adsorption isotherm setup with integrated digital temperature control unit for measuring adsorbed gas.

The experimental setup also includes a water bath at the bottom of the adsorption isotherm setup to immerse the reference/reference cell fully with the water and to maintain uniform temperature of sample cell. Water bath consists of 4 different chambers for maintaining 4 different temperatures. Size of the each chamber is 18″×18′×24″. The inner wall of the bath is made of heavy gauge stainless steel sheet and outer wall stainless steel sheet provide with thick layer glass insulation with ceramic blanket coated between the two walls to minimize heat loss.

A mechanical stirrer is attached with the water bath connected with electrical motor, which agitates the liquid to the bath to maintain uniformity of temperature throughout the chamber. Heaters have been provided for heating up the water. Sensors are merged within the water of the each water bath for controlling the temperature. Separate digital display has been attached with each sensor for the temperature display of 4 separate chambers.

An attached data acquisition system to collect the frequent data at very small change in volume is also provided.

Present invention provides one ended fully leakage proof sample/reference cell calibrated at a huge pressure amount of 6000 psi.

A rolling mill for crushing of samples as a feed of the sample chamber according to the different standard rules is also available.

The equilibrated moisture coal sample is put into the sample cell. Vacuum pump is used to evacuate the air present in the sample cell as well as reference cell. As reference cell and sample cells are kept in water bath, the water bath should be at the desired temperature for the isotherm determination. Valves to the vacuum pump and sample cell are firstly closed and valves to reference cells are opened. Helium gas is injected into the reference cell at known pressure as it is considered as a non-adsorbing gas and it has smallest molecular diameter. Now valves to reference cell are closed and allowed to equilibrate with the water bath temperature for one hour. For the determination of void volume, reference cells is connected to the sample cells to allow helium gas to enter the sample cell and allow the cells to achieve pressure and temperature equilibrium. A drop in pressure is recorded which determines the dead volume. After determination of dead volume, valves to reference cells, sample cells and vacuum lines are opened. The whole system is now evacuated. Valves to a vacuum pump and sample cells are then closed and valves to reference cells are opened. The adsorbate gas introduced into the sample cells at a known pressure. Valves to reference cells are closed and is allowed to equilibrate with the water bath temperature for one hour. Valve to the sample cells are now opened and the adsorbate gas is slowly admitted to sample cells. Sample is left for at least one hour to attained pressure and temperature equilibrium in the sample cell. Pressure drop is measured and the volume adsorbed is calculated. A graph of partial pressure or concentration vs volume of gas adsorbed by the solid is plotted which represents the adsorption isotherms.

The present apparatus provides a precise measurement of adsorption capacity of any gaseous sorbate on the solid sorbent. More precisely it measures the maximum adsorption capacity on a solid coal/shale samples. Moreover, this invention is solely distinctive, as the four numbers are water chambers are fully isolated with each other and each one is connected with single separate channel. By virtue of which this apparatus is able to perform the experiment for four different samples at four different conditions. The instrument is capable of measure the negligible amount adsorption/desorption with the high accuracy pressure transducer at high pressures. The adsorption comprises of the steps of pouring the known volume solid sample into the sample vessel and concurrently evacuating the existing air or gas from the sample vessel and the tubing; injecting of non-adsorbate gases specially helium for the measurement of void volume; re evacuation of the system; injecting of adsorbate gases in different steps of pressures at predetermined reservoir temperature for the measurement of adsorbed gas volume. Likewise steps of desorption include the measurement of desorbed gas volume at constant temperatures by venting out the gas from the samples vessel at different pressure steps.

The present invention is especially distinct as it can with stand with maximum pressure of 40 MPa corresponding to a burial depth of 4000 m. Moreover, samples vessels are also able resist 6000 Psi pressure. The apparatus is also enabling to handle the toxic, reactive and highly flammable gases. Mentioning high temperature with an accuracy of 0.1° C. is another unique feature of the present invention.

Gas is injected or vent out in steps from the sample vessel containing of known volume of solid adsorbent after reaching the equilibrium pressure. Present invention is also capable to avoid the contamination in the adsorbate as the vacuum pump is the connected with the whole system, which evacuates the previously accumulated gas within the system.

Present invention also measures the desorption isotherm as an alternate method of canister desorption test and establish the equilibrium pressure of the desorbate as it is vent out from the sample vessels as a function of time.

The present invention relates to a method and an experimental setup for adsorption/desorption isotherm measurement by volumetric method for coal/shale samples, which can construct the adsorption present invention relates to a unique apparatus wherein four separate channel has been fabricated through which adsorption isotherm experiment of four samples can run simultaneously from single gas injection point. This is a unique experimental setup in a way, where adsorption isotherm measurement of four different samples in four different temperature can be performed at a time. The water bath attached to apparatus for maintaining isotherm having temperature precision of 0.1° C. The present innovation is also capable of performing isotherms for any gases irrespective of gas composition up to the maximum pressure of 40 MPa. Vent out of gases from the system can be done individually or simultaneously for four separate channels through a single vent out point according to the requirement of declining pressure step during desorption. Similarly vacuum process can be done separately for each separate channels without hampering the pressure condition of other channels.

### Examples

Following examples are given by way of illustration and therefore should not be construed to limit the scope of the invention.

The plot of maximum amount of gas that can be adsorbed to a adsorbent at constant temperature at equilibrium as a function of pressure is known as adsorption isotherm. It represents the sorption capacity or maximum amount of gas that can be stored within a particular coal/shale. The adsorption capacity differs from surface condition to that of reservoir condition. The moisture content is an important parameter influencing adsorption capacity. The equilibrium moisture is considered to be equivalent to bed moisture. Hence to measure the actual adsorption capacity of coal/shale at reservoir condition with the present invention, crushed coal samples (−72 mesh BSS) was moisture equilibrated at 96-97% relative humidity condition prior to the experiment (value presented in tables). The adsorption isotherm determination experiment of the moisture equilibrated samples involves mainly two stages:
1. Measurement of void space (void volume) in the samples.
2. Determination of adsorption capacity.

In this experiment adsorbate (pure methane or any adsorbate gas) is supplied to adsorbent (coal sample) to adsorb gas molecule at reservoir temperature and pressure and the adsorbed gas volume is calculated by drop in pressure transducer.

In the present invention adsorption capacity has been measured with different adsorbent (coal/shale) and different adsorbate gas to fulfil the different purpose. Example 1 showing the adsorption of pure methane in coal, which determine the methane adsorption capacity of particular coal/shale reservoir. Example 2 showing the CO₂ adsorption capacity, which helps in prediction of CO₂ sequestration capacity in certain coals and CH₄ recovery potential. As, Coalbed methane (CBM) is not consists of pure methane, having few amount of CO₂, Example 3 consist of a mixture gas adsorption capacity of a particular coal for the prediction of actual adsorption capacity in terms of CBM reservoir. Adsorption capacity of the samples has been reported in the table in terms of Langmuir Volume (V_{L}). Results of the experiments performed with pure CH₄, pure CO₂ and mixture gas has been tabulated below.

Measurement of desorption isotherm is an indirect method for determining the gas storage capacity of the solid adsorbent. It signifies the reverse process of adsorption and helps to determining the critical desorption pressure and maximum desorption capacity from a particular coal/shale sample. The desorption data used to estimate the amount of gas that can be recovered from a given coal/shale horizon and to optimize the production of CBM/shale gas. Hysteresis generated between adsorption and desorption isotherm curve depicts the sorption characteristics of adsorbents. Desorption isotherm measurement is performed after the completion of adsorption, by venting out adsorbate gas from the sample cell and to establish the equilibrium pressure in a step-wise manner to construct the desorption isotherm.

### Example 1: High Pressure Methane Adsorption/Desorption Isotherm Construction

| Input Sample Details | | Proximate Analysis (air dried basis) | | | |
|---|---|---|---|---|---|
| Sample | AI-CH4/01 | Moist (%) | 0.6 | Ash (dry) | 20.6 |
| Density (g/cc) | 1.51 | Ash (%) | 20.5 | VM (dry) | 22.3 |
| Temperature(° C.) | 63.5 | VM (%) | 22.2 | FC (dry) | 57.0 |
| Eq. Moist (%) | 1.0 | FC (%) | 56.7 | VM (daf) | 28.1 |
| | | | | FC (daf) | 71.9 |

| Adsorption Isotherm | | | Desorption Isotherm | | |
|---|---|---|---|---|---|
| | Adsorbed Gas | | | Desorbed Gas | |
| | Content, cc/g | | | Content, cc/g | |
| Pressure | Moisture | | Pressure | Moisture | |
| (KPa) | Equilibrated | daf | (KPa) | Equilibrated | daf |
| 0 | 0.0 | 0.0 | 6893 | 6.8 | cc/g |
| 337 | 1.1 | 1.4 | 6129 | 6.6 | 8.7 |
| 803 | 1.9 | 2.5 | 5434 | 6.3 | 8.3 |
| 1288 | 2.6 | 3.3 | 4726 | 6.1 | 8.0 |
| 1778 | 3.4 | 4.3 | 4013 | 5.6 | 7.7 |
| 2627 | 4.5 | 5.8 | 3275 | 5.4 | 7.1 |
| 3606 | 5.5 | 7.0 | 2567 | 5.0 | 6.9 |
| 4597 | 6.2 | 7.8 | 1869 | 4.0 | 6.3 |
| 5628 | 6.7 | 8.6 | 1171 | 3.0 | 5.1 |
| 6609 | 7.2 | 9.2 | 497 | 1.6 | 3.9 |
| 7631 | 7.5 | 9.6 | | | 2.0 |

Result Summary

| | | | | |
|---|---|---|---|---|
| Langmuir | Moisture | daf | Langmuir | 3826 |
| Volume | Equilibrated | | Pressure | |
| (V_{L}, cc/g) | 11.3 | 14.3 | (P_{L}, KPa) | |

### Example 2: High Pressure Carbon Di-Oxide Adsorption/Desorption Isotherm Construction

| Input Sample Details | | Proximate Analysis (air dried basis) | | | |
|---|---|---|---|---|---|
| Sample | AI-CO₂/02 | Moist (%) | 1.9 | Ash (dry) | 31.0 |
| Density (g/cc) | 1.64 | Ash (%) | 30.4 | VM (dry) | 5.0 |
| Temperature(° C.) | 72 | VM (%) | 4.9 | FC (dry) | 64.0 |
| Eq. Moist (%) | 3.3 | FC (%) | 62.8 | VM (daf) | 7.2 |
| | | | | FC (daf) | 92.8 |

| Adsorption Isotherm | | | Desorption Isotherm | | |
|---|---|---|---|---|---|
| | Adsorbed Gas | | | Desorbed Gas | |
| | Content, cc/g | | | Content, cc/g | |
| Pressure | Moisture | | Pressure | Moisture | |
| (KPa) | Equilibrated | daf | (KPa) | Equilibrated | daf |
| 0 | 0.0 | 0.0 | 6641 | 25.8 | 38.7 |
| 211 | 4.3 | 6.4 | 5973 | 24.6 | 36.9 |
| 693 | 7.9 | 11.9 | 5300 | 24.1 | 36.1 |
| 1200 | 10.7 | 16.1 | 4602 | 23.2 | 34.7 |
| 1742 | 13.3 | 19.9 | 3944 | 21.5 | 32.2 |
| 2264 | 14.9 | 22.4 | 3241 | 20.5 | 30.7 |
| 2781 | 16.7 | 25.0 | 2903 | 19.3 | 29.0 |
| 3283 | 18.2 | 27.3 | 2570 | 17.8 | 26.7 |
| 3820 | 19.6 | 29.4 | 2212 | 17.5 | 26.2 |
| 4672 | 21.5 | 32.3 | 1864 | 16.1 | 24.1 |
| 5674 | 22.7 | 34.0 | 1521 | 14.7 | 22.0 |
| 6661 | 23.4 | 35.1 | 1213 | 13.0 | 19.5 |
| 7353 | 25.4 | 38.1 | 920 | 11.1 | 16.7 |
| | | | 582 | 8.6 | 12.8 |
| | | | 304 | 6.0 | 8.9 |

Result Summary

| | | | | |
|---|---|---|---|---|
| Langmuir | Moisture | daf | Langmuir | 2140 |
| Volume | Equilibrated | | Pressure | |
| (V_{L}, cc/g) | 31.2 | 46.8 | (P_{L}, KPa) | |

### Example 3: Mixture Gas Adsorption/Desorption Isotherm Construction

| Input Sample Details | | Proximate Analysis (air dried basis) | | | |
|---|---|---|---|---|---|
| Sample | AI-Mix/03 | Moist (%) | 1.1 | Ash (dry) | 20.7 |
| Density (g/cc) | 1.47 | Ash (%) | 20.5 | VM (dry) | 26.5 |
| Temperature(° C.) | 55 | VM (%) | 26.2 | FC (dry) | 52.8 |
| Eq. Moist (%) | 1.7 | FC (%) | 52.2 | VM (daf) | 33.4 |
| | | | | FC (daf) | 66.6 |

| Adsorption Isotherm | | | | | |
|---|---|---|---|---|---|
| | Adsorbed Gas | | Desorption Isotherm | | |
| | Content, cc/g | | | Desorbed Gas | |
| Pressure | Moisture | | Pressure | Content, cc/g | |
| (KPa) | Equilibrated | daf | (KPa) | Moisture Equilibrated | daf |
| 0 | 0.0 | 0.0 | 11361 | 9.3 | 11.9 |
| 411 | 1.0 | 1.3 | 10688 | 9.3 | 11.9 |
| 943 | 1.7 | 2.1 | 9970 | 9.5 | 12.2 |
| 1430 | 2.6 | 3.4 | 9252 | 8.9 | 11.4 |
| 1902 | 3.4 | 4.4 | 8544 | 8.5 | 10.9 |
| 2754 | 4.2 | 5.4 | 7791 | 8.1 | 10.4 |
| 3741 | 5.1 | 6.6 | 7043 | 7.7 | 9.8 |
| 4733 | 5.7 | 7.3 | 6340 | 7.5 | 9.6 |
| 5766 | 6.2 | 7.9 | 5642 | 7.4 | 9.5 |
| 6712 | 6.7 | 8.6 | 4954 | 6.6 | 8.5 |
| 7701 | 7.2 | 9.3 | 4221 | 6.4 | 8.2 |
| 8702 | 7.7 | 9.9 | 3533 | 5.4 | 7.0 |
| 9763 | 8.2 | 10.6 | 2788 | 4.5 | 5.8 |
| 10753 | 8.6 | 11.1 | 2002 | 3.9 | 5.0 |
| 11762 | 8.7 | 11.1 | 1318 | 3.2 | 4.1 |
| 12034 | 8.9 | 11.4 | 110 | 0.5 | 0.6 |

Result Summary

| | | | | |
|---|---|---|---|---|
| Langmuir | Moisture | daf | Langmuir | 5752 |
| Volume | Equilibrated | | Pressure | |
| (V_{L}, cc/g) | 12.9 | 16.6 | (P_{L}, KPa) | |

### Advantages of the Invention

The main advantages of this apparatus are:
1. Adsorption isotherm can be conducted up to adsorbate pressure of 40 MPa, corresponding to the 4000 meter depth of burial.
2. a unique apparatus has been claimed where four separate channel has been fabricated through which adsorption isotherm experiment of four samples can run simultaneously from single gas injection point
3. There is provision for analyzing four samples simultaneously at varying P-T conditions corresponding to the seam depth from which the samples are collected.
4. This research has the potential to develop better understanding about CBM, enhanced coalbed methane (ECBM-CO₂) recovery and CO₂-sequestration in suitable geologic candidates.
5. Maintaining isothermal condition through water bath is less expensive compare to nitrogen and air bath.

1-10. (canceled)

11. An efficient volumetric high pressure adsorption isotherm apparatus comprising a body of the adsorption isotherm apparatus and a water bath, wherein the body of adsorption isotherm apparatus further comprises:
a) a manifold maintained at a predetermined temperature (T) and having a known geo metric volume (Vs) with four different channels having a set of reference and sample cells;
b) a stainless steel reference cell and a sample cell calibrated at a pressure range of O to 6000 psi, connected to the manifold via a valve and a constant temperature water bath;
c) a gas inlet/outlet line connected to the manifold via a valve;
d) a set of digital temperature display unit and a thermocouple, wherein the digital temperature display unit is mounted with the thermocouple to maintain a constant temperature for each of the four channels to analyse four different samples;
e) a seamless tubing for injecting gases into the sample cell and concurrently evacuating the existing air or gas from the channels (both reference cell and sample cell);
f) a two-stage diaphragm-sensing pressure gauge (0-40 MPa) for monitoring injection gas pressure;
g) Strain gauge-based pressure transducer for measuring negligible amount of adsorption/desorption with the high accuracy at all pressures ranging between 0-40 Mpa;
wherein the water bath is at the bottom of the adsorption isotherm apparatus to immerse the stainless-steel reference cell and the sample cell fully with the water;
wherein the water bath is separated in four channels to perform experiment, at a time, on four different samples at temperatures corresponding to their geologic reservoir depths; and
wherein the four samples can run simultaneously from single gas injection point.

2. The apparatus as claimed in claim 1, wherein the water bath has an inner wall made of heavy gauge stainless steel sheet and an outer wall made of stainless-steel sheet is further provided with a thick layer glass insulation with ceramic blanket coated between the two walls to minimize heat loss; wherein the size of each section of the water bath is 18″×18″×24″; wherein the water bath is attached with a mechanical stirrer connected to an electrical motor, wherein the mechanical stirrer agitates the liquid in the water bath to maintain uniformity of temperature throughout the chamber; wherein the apparatus further comprises an attached data acquisition system to collect the frequent data at a small change in pressure.

3. The apparatus as claimed in claim 1, wherein said apparatus is for the adsorption isotherm construction and determination of adsorption capacity of the solid adsorbent, and for the desorption isotherm construction for the solid desorbent.

4. A process for the construction of adsorption isotherm and determination of adsorption capacity of the solid adsorbent using the apparatus as claimed in claim 1, comprising the steps of:
i. moisture equilibrating the crushed coal/shale samples (−72 mesh BSS) at 96-97% relative humidity to obtain equilibrated moisture coal sample;
ii. providing a known volume sample cell (150 cc) maintained at corresponding geologic reservoir temperature with a provisions for continuous gas injection and vent out;
iii. putting the equilibrated moisture coal/shale sample as obtained in step (i) into the sample cell of step (ii);
iv. evacuating the air/gas present in the reference cell, sample cell and tubing in each channel through the vacuum pump;
v. maintaining the temperature of the water bath of the reference cells and sample cells at the desired geologic reservoir temperature for the isotherm construction;
vi. closing the valves to vacuum pump and sample cells and opening the valves to reference cells;
vii. injecting the inert gas into the reference cell to a known pressure followed by closing the valve to reference cells and allowing the pressure to equilibrate at the water bath temperature;
viii. connecting the reference cell with sample cell and to attain pressure equilibrium;
ix. correlating the amount of inert gas and equilibrium pressure to determine void space;
x. opening the valves of the sample cells, reference cells and vacuum lines;
xi. evacuating the whole system to ensure that there should not be air or any other gases are present;
xii. closing the valves to vacuum pump and sample cells and opening inlet line valves to the reference cells;
xiii. introducing the adsorbate gas into the reference cells at different pressure steps;
xiv. closing the valves to reference cells and equilibrating the pressure at the water bath temperature for one hour;
xv. opening the valves to sample cells and admitting the adsorbent gas to the sample cells;
xvi. recording the drop in equilibrium pressure in the sample cell at water bath temperature;
xvii. increasing the pressure m the reference cell to the next pressure step by adjusting the regulator on the gas cylinder;
xviii. repeating the steps at increasing pressures as per the desired pressure up to 40 MPa; and
xix. correlating the amount of gaseous adsorbate, void space and equilibrium pressure to determine the adsorption capacity and construct the adsorption isotherm.

5. The process as claimed in claim 4, wherein said inert gas is selected from helium or argon for the measurement of void volume.

6. A process for the construction of desorption isotherm of the solid desorbent for the desorbate gas using the apparatus as claimed in claim 1, comprising the steps of:
i. providing an evacuated chamber/reference cell of known volume and maintained at a predetermined temperature (corresponding to the depth of geologic reservoir) with a vent out system;
ii. Previously degassed sample of desorbent present therein having the adsorbate gas at equilibrium condition with the water bath temperature;
iii. establishing the equilibrium pressure of the gaseous desorbate as its being vent out, in a stepwise manner from the sample cell. as a function of adsorbate gas concentration; and
iv. correlating the amount of gaseous desorbate and equilibrium pressure to construct the desorption isotherm.

7. The process as claimed in claim 4, wherein the gaseous adsorbate/desorbate is a physisorbate and the process occurs is fully physisorption.

8. The process as claimed in claim 6, wherein the gaseous adsorbate/desorbate is a physisorbate and the process occurs is fully physisorption.

9. The process as claimed in claim 4, wherein the temperature of the water bath is maintained substantially throughout the adsorption/desorption process.

10. The process as claimed in claim 4, wherein the adsorbent/desorbent are selected from coal or shale or any adsorbent solid.

11. The process as claimed in claim 6, wherein the adsorbent/desorbent are selected from coal or shale or any adsorbent solid.

12. The process as claimed in claim 4, wherein said adsorbate/desorbate gas is selected from the group consisting of methane, carbon dioxide, nitrogen or any adsorbate/desorbate gas.

13. The process as claimed in claim 6, wherein said adsorbate/desorbate gas is selected from the group consisting of methane, carbon dioxide, nitrogen or any adsorbate/desorbate gas.
